(19) United States
(12) Patent Application Publication
(10) Pub. No.: US 2021/0341226 A1
(43) Pub. Date: Nov. 4, 2021

(54) SYSTEM, METHOD, AND APPARATUS FOR CLEANING INDUSTRIAL FURNACES AND ASSOCIATED STRUCTURES

(71) Applicant: Integrated Global Services Inc., Richmond, VA (US)

(72) Inventors: Jefferson Landers Shelton, Jacksonville, AL (US); Mark Braithwaite, JR., Richmond, VA (US); Morgan Watson, Chesterfield, VA (US); Chris Landers, Anniston, AL (US); Connor Berry Shelton, Jacksonville, AL (US); Andrew Kline, Richmond, VA (US)

(73) Assignee: Integrated Global Services Inc., Richmond, VA (US)

(21) Appl. No.: 17/302,367

(22) Filed: Apr. 30, 2021

Related U.S. Application Data
(60) Provisional application No. 63/018,169, filed on Apr. 30, 2020.

(51) Int. Cl. F27D 25/00; B08B 5/02

(52) U.S. Cl. CPC F27D 25/008; B08B 5/02

(57) ABSTRACT

System, method, and apparatus for cleaning industrial furnaces and associated structures. The system improves the dynamic pressure and cleaning of conventional air cannon systems utilizing air as a pressurized gas source for discharge by the air cannon. According to the present invention, the pressurized gas source is selected to have a density greater than air at an equivalent temperature. The increased density of the pressurized gas source improves the cleaning capability of the conventional air cannon for removing stubborn deposits.

### CROSS-REFERENCE TO RELATED APPLICATION

This application claims the benefit of priority of U.S. provisional application No. 63/018,169 filed Apr. 30, 2020, the contents of which are herein incorporated by reference.

### BACKGROUND OF THE INVENTION

The present invention relates to cleaning systems for industrial furnaces and associated structures, and more particularly to air cannons and soot blowers utilized in cleaning the industrial furnaces and associated structures.

Air cannons and soot blowers are typically utilized for periodic cleaning of industrial furnaces to remove deposits that accumulate within the structures and decrease efficiency or increase unwanted emissions from the furnaces.

Conventional thinking in the air cannon market focuses on a peak force developed by the air cannon to determine a cleaning force. By contrast, conventional thinking in the soot blower market presents dynamic pressure as the key to deposit removal in industrial furnaces. Despite the availability and employment of these systems, stubborn deposits still accumulate that neither of these systems can remove. These will typically require the plant to be taken off-line in order to remediate the stubborn deposits.

As can be seen, there is a need for an improved cleaning system for industrial furnaces and associated structures.

### SUMMARY OF THE INVENTION

In one aspect of the present invention, an air cannon system for removal a deposit in a coal fired industrial plant is disclosed. The system includes a large volume tank for containment of a charge of a pressurized gas. A quick exhaust fitting is coupled with an outlet of the large volume tank. The quick exhaust fitting is operable to release the charge of the pressurized gas to an air cannon nozzle oriented to direct a blast from a release of the pressurized gas at the deposit. A source communicating the pressurized gas in communication with the large volume tank to selectively charge the large volume tank with the charge of the pressurized gas. The pressurized gas is selected from the group consisting of carbon dioxide and argon.

In some embodiments, a dynamic pressure of the blast at 1 foot from the air cannon nozzle is at least 500 lbf. A dynamic pressure of the blast may be at least 100 lbf at a downstream position of at least 12 feet from the air cannon nozzle. A dynamic pressure of the blast may be at least 50 lbf to a downstream position of at least 14 feet from the air cannon nozzle. A dynamic pressure of the blast may also be at least 300 lbf to a downstream position of at least 4 feet from the air cannon nozzle.

In other aspects of the invention, a method of cleaning a deposit from a coal fired industrial plant is disclosed. The method includes charging a large volume tank for containment of a charge of a pressurized gas. The source of the pressurized gas is selectively communicated with the large volume tank to charge the large volume tank with the charge of the pressurized gas. The pressurized gas is selected from the group consisting of carbon dioxide and argon. A quick exhaust fitting is coupled with an outlet of the large volume tank. The quick exhaust fitting is operable to release the charge of the pressurized gas to an air cannon nozzle oriented to direct a blast from the pressurized gas at the deposit.

In some embodiments, a dynamic pressure of the blast at 1 foot from the air cannon nozzle is at least 500 lbf. The method includes directing the blast with a dynamic pressure of at least 100 lbf to a downstream position of at least 12 feet from the air cannon nozzle. The method may also include directing the blast with a dynamic pressure of at least 50 lbf to a downstream position of at least 14 feet from the air cannon nozzle.

In some embodiments, the method the air cannon nozzle is a high velocity nozzle.

In other embodiments, the method includes directing the blast with a dynamic pressure of at least 500 lbf at a downstream position of at least 1 foot from the air cannon nozzle.

In other embodiments, the method includes directing the blast with a dynamic pressure of at least 300 lbf to a downstream position of at least 4 feet from the air cannon nozzle.

These and other features, aspects and advantages of the present invention will become better understood with reference to the following drawings, description and claims.

### BRIEF DESCRIPTION OF THE DRAWINGS

FIG. 1 is a drawing illustrating of an apparatus for cleaning industrial furnaces and associated structures.

FIG. 2 illustrates a computational fluid dynamics (CFD) simulation comparing dynamic pressure for various nozzles and charge gasses.

FIG. 3 illustrates a CFD simulation comparing nozzle velocities for various nozzles and charge gasses.

FIG. 4 is a chart showing a force comparison between a high velocity air charge and a high velocity carbon dioxide (CO₂) charge.

FIG. 5 is a table showing a nozzle force comparison between a high velocity air charge and a high velocity CO₂ charge.

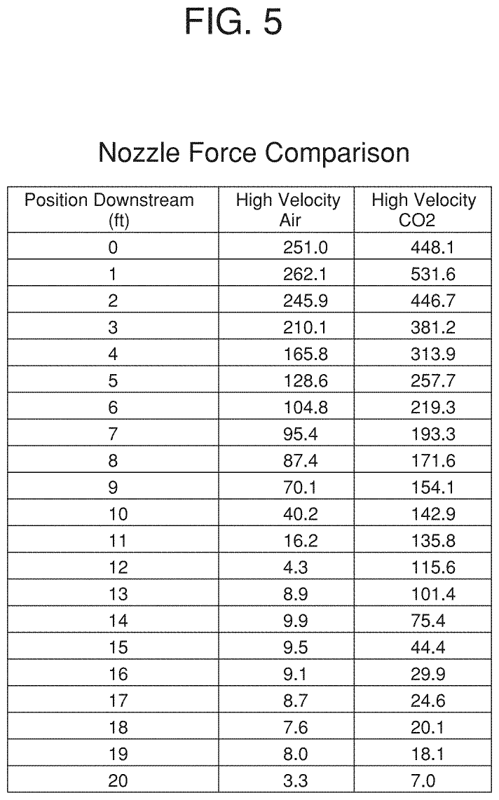

### DETAILED DESCRIPTION

The following detailed description is of the best currently contemplated modes of carrying out exemplary embodiments of the invention. The description is not to be taken in a limiting sense but is made merely for the purpose of illustrating the general principles of the invention.

Broadly, embodiments of the present invention provide a system, method, and apparatus for removal of deposits from industrial furnaces and associated equipment. The present invention utilizes a pressurized gas source in an air cannon for remediation of deposits, where the pressurized gas source has a density greater than that of compressed air at an equivalent temperature.

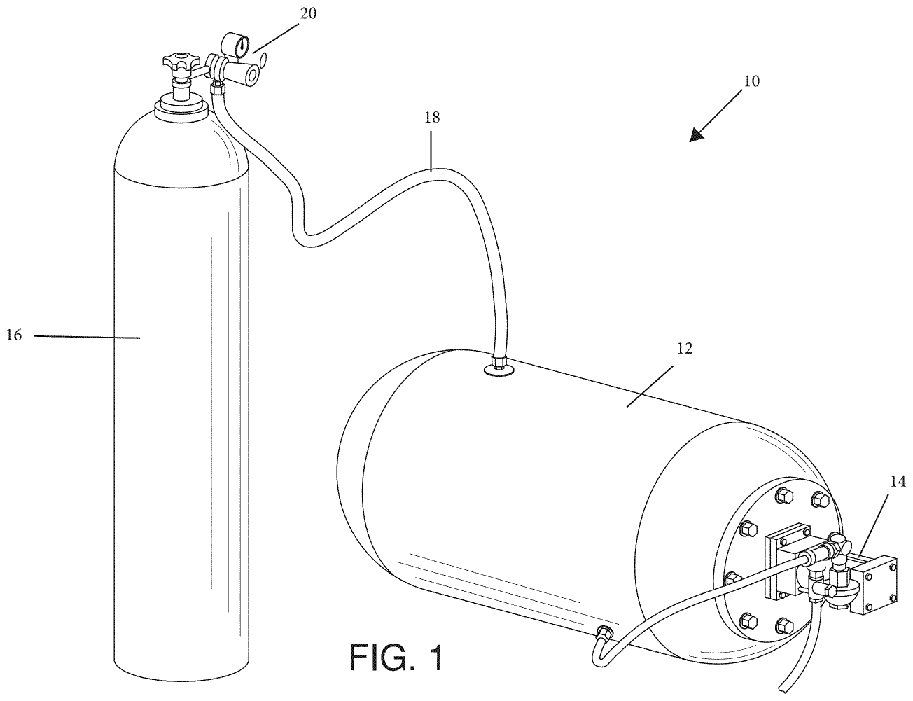

As seen in reference to FIG. 1, a system according to aspects of the present invention includes an air cannon (not shown) equipped with a large volume tank 12, such as a #150 tank to contain a charge of the pressurized gas. A quick exhaust fitting 14 is provided at an outlet of the large volume tank 12. The quick exhaust fitting 14 is operable to release the charge of the pressurized gas to a conduit having a proximal end and a distal end. The proximal end is connected to the quick exhaust fitting 14 while the distal end is fitted with a nozzle to direct the released charge at the deposit within the industrial furnace.

The large volume tank 12 is coupled to the source of the pressurized gas 16 via a supply conduit 18, which may be a stainless-steel braided hose, stainless steel pipe, and the like. The supply conduit 18 is connected at a pressure regulator 20 at a fitting for the pressurized gas source 16. The pressurized gas source 16 may be a portable replaceable cylinder, or it may include a stationary cylinder that is coupled to a pressurized gas generator to recharge the stationary cylinder.

As indicated previously, the gas is selected to have a density that is greater than that of air at an equivalent temperature and pressure. By way of non-limiting example, the gas may include carbon dioxide (CO2) and Argon, which are readily available for use in industrial processes. Carbon dioxide is a relatively inexpensive source of gas and is a normal byproduct of the combustion of the industrial process. Its use for selectively cleaning of deposits may be contained by downstream CO2 emissions remediation employed at the operating plant. The high-density gas is selected to increase the dynamic pressure of the system 10 and improve cleaning of the deposits. The inventors have determined that the kinetic energy and momentum of the released gas charge of CO2 can achieve a substantial increase in the dynamic pressure delivered to clean stubborn deposits. Where they dynamic pressure is determined according to the following equation:

$$q = \frac{1}{2} \times p \times {v}^{2}$$

$$q = Dynamic Pressure$$

$$p = Air Density$$

$$v = Air Velocity ( TAS )$$

Operating parameters include a pressure increased to 200 psi yields a greater velocity in the released charge with a dramatic increase in dynamic pressure and cleaning capability for an equivalent released charge of air. In addition to providing the ability to clean stubborn deposits, when employed with CO2, the system 10 effectively doubled the cleaning area achieved by the air cannon.

In preferred embodiments, the system 10 is designed to be manually fired for particularly stubborn deposits that are resistant to clearing with conventional air cannon discharges utilizing compressed air.

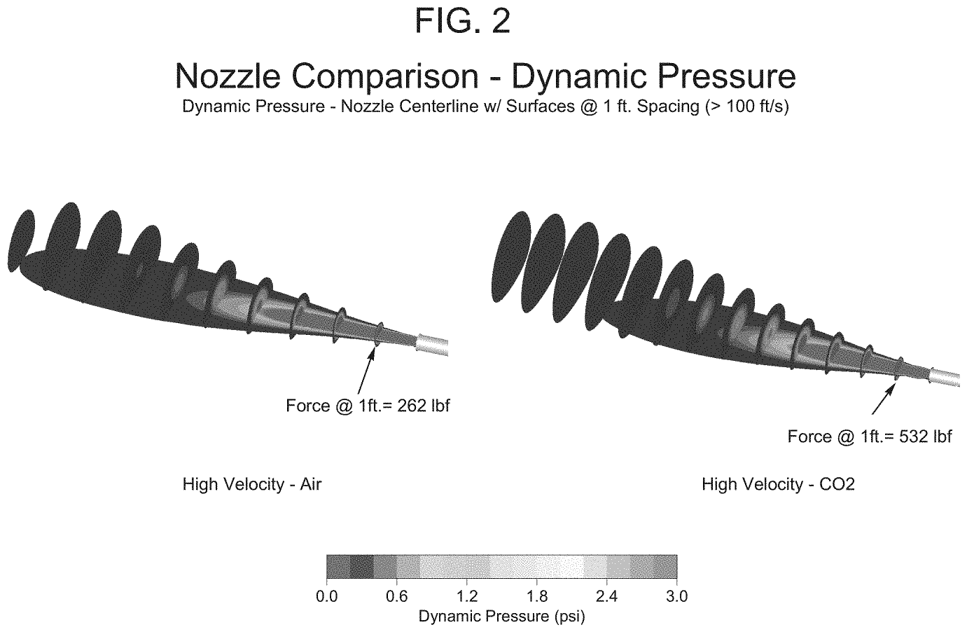

As seen in reference to FIG. 2 showing a computational fluid dynamics (CFD) simulation comparing a standard air cannon nozzle discharge with conventional high velocity air versus that of an identical system charged with CO₂. At 1 foot from a discharge end of the air cannon nozzle, the dynamic pressure of the air cannon blast is 262 lbf for the air cannon charged with conventional air. Under the same operating conditions, the air cannon system charged with CO₂ generates a dynamic pressure of 532 lbf.

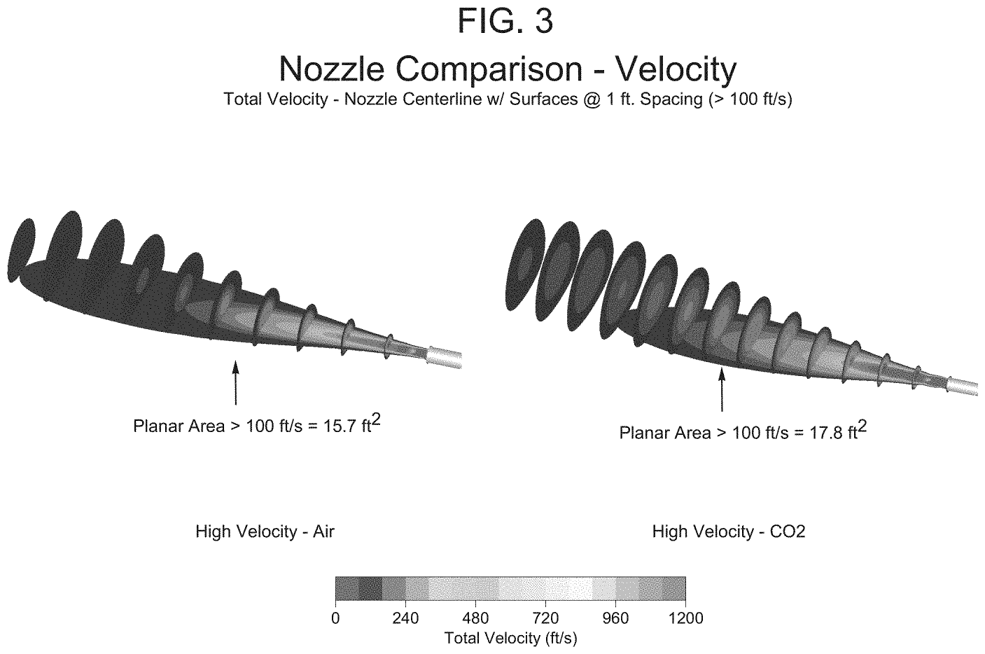

As seen in reference to FIG. 3, showing a comparison of nozzle velocities for a standard air cannon nozzle discharge with conventional high velocity air versus that of an identical system charged with CO₂. In this case, a planar area where the velocity of the air cannon blast is greater than 100 ft/s is 15.7 ft² for the conventional air charge, while that of the CO2 charge is 17.8 ft².

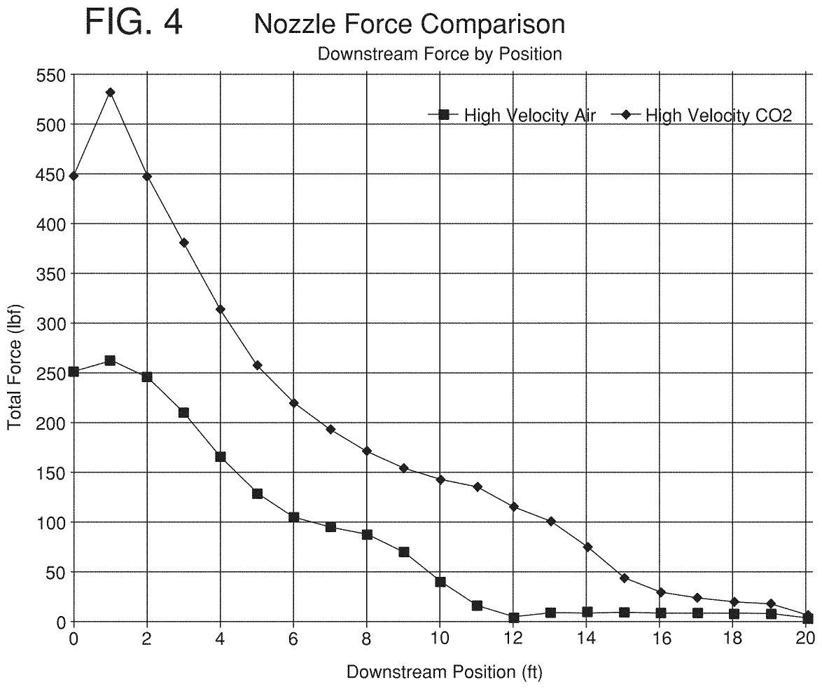

As seen in reference to FIG. 4, showing a downstream force developed by the air cannon at selected positions from the air cannon nozzle, the identical system when charged with CO2 can sustain blast forces in excess of 100 lbf out to a downstream position of at least 13 ft and a blast force of in excess of 50 lbf out to a downstream position of at least about 15 ft. Under the same conditions, the conventionally charged air cannon can only sustain blast forces exceeding 100 lbf to about 7 ft and drops to less than 50 lbf at a downstream distance of less than 10 ft.

The foregoing system is capable of developing a dynamic pressure of the blast at 1 foot from the air cannon nozzle is at least 500 lbf, preferably to at least 538 lbf. The blast is also capable of developing a dynamic pressure of at least 100 lbf to a downstream position to at least 10 feet, preferably to at least 12 feet from the air cannon nozzle. The blast with a dynamic pressure of at least 50 lbf to a downstream position of at least 12 feet, more preferably to about 14 feet from the air cannon nozzle. The blast may also generate a dynamic pressure of at least 300 lbf to a downstream position of at least 3 to about 4 feet from the air cannon nozzle.

As will be appreciated from the foregoing, the performance of the conventional air cannon can be greatly enhanced by the utilization of a charge gas having a density greater than that of conventional air. The system of the present invention can be highly effective in dislodging stubborn deposits where conventionally charged air cannon are unable to do so. Dislodging these stubborn deposits with the air cannon charged according to the present invention can allow the plant to remain operational for longer durations without the need to come off-line for removal of these deposits.

In some embodiments, the system may be integrated with an existing air cannon system, where one or more of the air cannons in the system are selectively charged with the high-density gas. Alternatively, the system may employ one or more stand-alone air cannon operatively connected to the source of high-density gas 16.

It should be understood, of course, that the foregoing relates to exemplary embodiments of the invention and that modifications may be made without departing from the spirit and scope of the invention as set forth in the following claims.

What is claimed is:

1. An air cannon system for removal a deposit in a coal fired industrial plant, comprising:
a large volume tank for containment of a charge of a pressurized gas;
a quick exhaust fitting coupled with an outlet of the large volume tank, the quick exhaust fitting operable to release the charge of the pressurized gas to an air cannon nozzle oriented to direct a blast from the pressurized gas at the deposit; and
a source communicating the pressurized gas in communication with the large volume tank to selectively charge the large volume tank with the charge of the pressurized gas, wherein the pressurized gas is selected from the group consisting of carbon dioxide and argon.

2. The air cannon system of claim 1, wherein a dynamic pressure of the blast at 1 foot from the air cannon nozzle is at least 500 lbf to about 538 lbf.

3. The air cannon system of claim 1, wherein a dynamic pressure of the blast is at least 100 lbf at a downstream position of between about 10 feet to about 12 feet from the air cannon nozzle.

4. The air cannon system of claim 1, wherein a dynamic pressure of the blast is at least 50 lbf to a downstream position of at least 12 feet from the air cannon nozzle.

5. The air cannon system of claim 1, wherein a dynamic pressure of the blast is at least 300 lbf to a downstream position of at least about 3 feet to about 4 feet from the air cannon nozzle.

6. A method of cleaning a deposit from a coal fired industrial plant, comprising:
charging a large volume tank for containment of a charge of a pressurized gas;
selectively communicating a source of the pressurized gas with the large volume tank to charge the large volume tank with the charge of the pressurized gas, wherein the pressurized gas is selected from the group consisting of carbon dioxide and argon;
selectively operating a quick exhaust fitting coupled with an outlet of the large volume tank, the quick exhaust fitting operable to release the charge of the pressurized gas to an air cannon nozzle oriented to direct a blast from the pressurized gas at the deposit.

7. The method of claim 6, further comprising:
wherein a dynamic pressure of the blast at 1 foot from the air cannon nozzle is at least 500 lbf.

8. The method of claim 6, further comprising:
directing the blast with a dynamic pressure of at least 100 lbf to a downstream position of at least 12 feet from the air cannon nozzle.

9. The method of claim 6, further comprising:
directing the blast with a dynamic pressure of at least 50 lbf to a downstream position of at least 14 feet from the air cannon nozzle.

10. The method of claim 6, wherein the air cannon nozzle is a high velocity nozzle.

11. The method of claim 6, further comprising:
directing the blast with a dynamic pressure of at least 500 lbf at a downstream position of at least 1 foot from the air cannon nozzle.

12. The method of claim 6 further comprising:
directing the blast with a dynamic pressure of at least 300 lbf to a downstream position of at least 4 feet from the air cannon nozzle.

13. An air cannon system for removal a deposit in a coal fired industrial plant, comprising:
a large volume tank for containment of a charge of a pressurized gas;
a quick exhaust fitting coupled with an outlet of the large volume tank, the quick exhaust fitting operable to release the charge of the pressurized gas to an air cannon nozzle oriented to direct a blast from the pressurized gas at the deposit; and
a source communicating the pressurized gas in communication with the large volume tank to selectively charge the large volume tank with the charge of the pressurized gas, wherein the pressurized gas has a density greater than that of air at an equivalent temperature and pressure.
